(19) United States
(12) Patent Application Publication
(10) Pub. No.: US 2026/0164497 A1
(43) Pub. Date: Jun. 11, 2026

(54) WIRELESS DEVICE PROPAGATION DELAY COMPENSATION IN RRC IDLE OR INACTIVE

(71) Applicant: Telefonaktiebolaget LM Ericsson (publ), Stockholm (SE)

(72) Inventors: Olof LIBERG, Enskede (SE); Magnus SANDGREN, Staffanstorp (SE); Mattias BERGSTRÖM, Singapore (SG); Magnus LARSSON, Sollentuna (SE); Yufei BLANKENSHIP, Kildeer, IL (US)

(21) Appl. No.: 19/126,729

(22) PCT Filed: Nov. 2, 2023
(86) PCT No.: PCT/SE2023/051110

§ 371 Date: May 2, 2025

Related U.S. Application Data
(60) Provisional application No. 63/422,166, filed on Nov. 3, 2022.

(51) Int. Cl. H04W 76/27; H04W 56/00

(52) U.S. Cl. CPC H04W 76/27; H04W 56/005

(57) ABSTRACT

A method, system and apparatus for wireless device (WD) propagation delay compensation in radio resource control (RRC) idle or inactive state are disclosed. According to one aspect, a method in a WD includes, while in a RRC CONNECTED state, obtaining a propagation delay compensation (PDC) configuration from the network node, the PDC configuration comprising a PDC value. The method also includes, while in an RRC INACTIVE or an RRC IDLE state: obtaining a time value signaled from the network node; determining whether the PDC value is valid; and when the PDC value is determined to be valid, using the PDC value to compensate the time value signaled from the network node.

### TECHNICAL FIELD

The present disclosure relates to wireless communications, and in particular, to wireless device (WD) propagation delay compensation in radio resource control (RRC) idle or inactive state.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

### INTRODUCTION

In 3GPP Technical Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since 3GPP Release 13, narrow band Internet of Things (NB-IoT) and LTE-M (LTE machine communications) are part of the LTE specifications and provide connectivity to massive machine type communications (mMTC) services.

In 3GPP Release 15, the first release of the 5G system (5GS) was specified. This is the new generation radio access technology (RAT) intended to serve use cases such as enhanced mobile broadband (eMBB), ultra-reliable and low latency communication (URLLC), and mMTC. 5GS includes the New Radio (NR) access stratum interface and the 5G Core Network (5GC).

During 3GPP Release 16 and 17, the 3GPP addressed support for different new use cases including support for time sensitive networking (TSN) and small data transmission (SDT). Now in 3GPP Release 18, the 3GPP has started work on enabling the 5G system to provide time as a service (Taas) with high reliability and accuracy.

### TSN Propagation Delay Compensation

To support TSN, 5G NR supports broadcast and unicast signaling of the Coordinated Universal Time (UTC). To compensate for the propagation delay, i.e., the signal time of flight (ToF), between a base station and a WD in radio resource control (RRC) connected state, 5GNR supports propagation delay estimation and compensation. A WD may, for example, add the estimated propagation delay to the UTC signaled by a base station to generate an accurate estimate of the actual UTC at the time of receiving the UTC signaled by the base station. FIG. 1 is a diagram illustrating the principle of propagation delay compensation applied to 5G NR system information block 9 UTC signaling.

Two different methods for supporting propagation delay compensation (PDC) were specified in 3GPP Release 17: timing advance (TA) and round-trip time (RTT) based compensation. The TA based method is based on the principle that the TA configured to a device for performing uplink (UL) communication is approximately equal to twice the RTT. So, TA/2 serves as an estimate of the base station to WD propagation delay.

In the RTT method, the radio base station (hereinafter referred to as a network node) and the WD reception and transmission timings are measured on the UL and downlink (DL) to determine the network node receive to transmit time difference, and the WD receive to transmit time difference (e.g., WD RxTxTimeDiff and network node RxTxTimeDiff in 3GPP standards such as, for example, 3GPP Technical Standard (TS) 38.215 v17.0.0) to estimate the propagation delay as (WD RxTxTimeDiff+network node RxTxTimeDiff)/2. These measurements are based on, for example, the tracking reference signal in the DL and the sounding reference signal in the UL. The detected timing of these signals supports a higher accuracy than the TA, which allows the RTT based method to perform with a higher precision than the TA based PDC method.

### Small Data Transmission

NR supports power efficient transmission of small data packets from RRC inactive state. The WD is pre-configured with a TA value by the network and is allowed to make use of the TA when performing UL transmissions from RRC inactive state. The WD may be required to validate the TA value before making use of it. One validation criterion corresponds to checking that the reference signal received power (RSRP) has not changed more than a configured threshold since receiving the TA configuration. A large change in RSRP is intended so serve as an indication that the WD has moved to such an extent that the pre-configured TA value has become outdated.

### Taas (Time as a Service)

Taas (Time as a service) is specified in 3GPP Release 18 studied by 3GPP SA2 in the study on 5G Timing Resiliency and time sensitive communications (TSC) and ultra-reliable and low latency communication (URLLC) enhancements. It is expected to be based on 5G NRs ability to distribute UTC over unicast and broadcast signaling. Several members of 3GPP SA2 have considered that the 5G NR system information block 9 (SIB9) UTC signaling will enable support of Taas to devices in RRC inactive or idle state.

Distributing time to devices in RRC inactive or idle state via SIB9 does not allow the devices to perform propagation delay compensation (PDC) in a uniform and predictable manner since 3GPP Release 17 PDC is only supported for WDs in RRC Connected state. This means that Taas for devices in RRC inactive or idle will be less reliable than a Taas for devices in RRC connected state that may correct the received UTC signaled by the network by one of the 3GPP Release 17 PDC methods.

### SUMMARY

Some embodiments advantageously provide methods, network nodes and wireless devices for wireless device (WD) propagation delay compensation in radio resource control (RRC) idle or inactive state.

Some embodiments provide support for PDC for WDs in RRC inactive state or RRC idle state to enable a more accurate time distribution. Some embodiments provide methods for pre-configuring a WD in RRC connected state to support subsequent PDC from RRC inactive state or idle state. Some embodiments provide methods for validating the PDC before making use of it in RRC inactive state or idle state.

One advantage of some embodiments is the achievement of better network control over the accuracy of distributed time for WDs in RRC inactive state or idle state.

According to one aspect, a method in a wireless device, WD, configured to communicate with a network node is provided. The method includes, while in a radio resource control, RRC, CONNECTED state, obtaining a propagation delay compensation, PDC, configuration from the network node, the PDC configuration comprising a PDC value. The method also includes, while in an RRC INACTIVE or an RRC IDLE state: obtaining a time value signaled from the network node; determining whether the PDC value is valid; and when the PDC value is determined to be valid, using the PDC value to compensate the time value signaled from the network node.

According to this aspect, in some embodiments, the method includes, when the PDC value is determined to be invalid, entering the RRC CONNECTED state and acquiring a subsequent PDC configuration. In some embodiments, the method includes, when the PDC value is determined to be invalid, adjusting the PDC value while in the RRC IDLE state or the RRC INACTIVE state. In some embodiments, adjusting the PDC value is based at least in part on: a change in position of the WD relative to the network node since the time of obtaining the PDC value; a change in reception time of downlink signals; or a change in time offset toward a local primary time. In some embodiments, the time value received from the network node is a coordinated universal time, UTC, or a global positioning system, GPS, time. In some embodiments, the method includes performing PDC based at least in part on the PDC value until the WD changes cells. In some embodiments, determining whether the PDC value is valid is based at least in part on a detected change in a signal measurement that is less than a first threshold. In some embodiments, the signal measurement is one of a reference signal received power, a reference signal received quality, a signal to interference plus noise ratio and a signal to noise ratio. In some embodiments, the detected change in signal measurement includes a change between a first sample of a signal measurement performed at a first time and a second sample of a signal measurement performed at a second time after the first time, the first time being a time when the PDC value was obtained. In some embodiments, the PDC value is determined to be invalid when an absolute value of a detected change in signal measurements exceeds a second threshold. In some embodiments, determining whether the PDC value is valid includes comparing to a third threshold, a difference in time between receipt of a first signal and receipt of a second signal. In some embodiments, the first signal is one of a synchronization signal, a physical broadcast channel, a tracking reference signal and a positioning reference signal from a cell camped on by the WD. In some embodiments, the second signal is one of a synchronization signal, a physical broadcast channel, a tracking reference signal and a positioning reference signal from a neighbor cell to a cell camped on by the WD. In some embodiments, determining whether the PDC value is valid includes determining a change in signal measurements over a sequence of times. In some embodiments, determining whether the PDC value is valid includes comparing to a fourth threshold a change in at least one of position and orientation of the WD. In some embodiments, determining whether the PDC value is valid includes comparing a PDC compensated version of the time value signaled from the network node and a local primary time. In some embodiments, the local primary time is a global navigation satellite system time. In some embodiments, the PDC configuration includes at least one of a PDC method, a permission to update the PDC value, a PDC validation method and a time interval during which the PDC configuration is to be applied by the WD. In some embodiments, the PDC method is one of a timing advance-based method and a round trip time-based method. In some embodiments, the round trip time-based method includes transmitting sounding reference signals, SRS, in RRC INACTIVE state, and the WD is configured to receive a time difference value based on measurements of SRS by the network node. According to another aspect, a wireless device, WD, configured to communicate with a network node is provided. The WD is configured to: while in a radio resource control, RRC, CONNECTED state, obtain a propagation delay compensation, PDC, configuration from the network node, the PDC configuration comprising a PDC value; and while in an RRC INACTIVE or an RRC IDLE state:
obtain a time value signaled from the network node; determine whether the PDC value is valid; and when the PDC value is determined to be valid, use the PDC value to compensate the time value signaled from the network node.

According to this aspect, in some embodiments, when the PDC value is determined to be invalid, enter the RRC CONNECTED state and acquire a next PDC configuration. In some embodiments, when the PDC value is determined to be invalid, adjust the PDC value while in the RRC IDLE state or the RRC INACTIVE state. In some embodiments, adjusting the PDC value is based at least in part on: a change in position of the WD relative to the network node since the time of obtaining the PDC value; a change in reception time of downlink signals; or a change in time offset toward a local primary time, or a global navigation satellite system time. In some embodiments, the time value received from the network node is a coordinated universal time, UTC, or a global positioning system, GPS, time. In some embodiments, the WD is configured to perform PDC based on the PDC value until the WD changes cells. In some embodiments, determining whether the PDC value is valid is based at least in part on a detected change in a signal measurement that is less than a first threshold. In some embodiments, the signal measurement is one of a reference signal received power, a reference signal received quality, a signal to interference plus noise ratio and a signal to noise ratio. In some embodiments, the detected change in signal measurement includes a change between a first sample of a signal measurement performed at a first time and a second sample of a signal measurement performed at a second time after the first time, the first time being a time when the PDC value was obtained. In some embodiments, the PDC value is determined to be invalid when an absolute value of a detected change in signal measurements exceeds a second threshold. In some embodiments, determining whether the PDC value is valid includes comparing to a third threshold, a difference in time between receipt of first signal and receipt of a second signal. In some embodiments, the first signal is one of a synchronization signal, a physical broadcast channel, a tracking reference signal and a positioning reference signal from a cell camped on by the WD. In some embodiments, the second signal is one of a synchronization signal, a physical broadcast channel, a tracking reference signal and a positioning reference signal from a neighbor cell to a cell camped on by the WD. In some embodiments, determining whether the PDC value is valid includes determining a change in signal measurements over a sequence of times. In some embodiments, determining whether the PDC value is valid includes comparing to a fourth threshold a change in at least one of position and orientation of the WD. In some embodiments, determining whether the PDC value is valid includes comparing a PDC compensated version of the time value signaled by the network node and a local primary time. In some embodiments, the local primary time is a global navigation satellite system time. In some embodiments, the PDC configuration includes at least one of a PDC method, a permission to update the PDC value, a PDC validation method and a time interval during which the PDC configuration is to be applied by the WD. In some embodiments, the PDC method is one of a timing advance-based method and a round trip time-based method. In some embodiments, the round trip time-based method includes transmitting sounding reference signals, SRS, in RRC INACTIVE state, and the WD is configured to receive a time difference value based on measurements of SRS by the network node.

According to another aspect, a method in a network node configured to communicate with a wireless device, WD, is provided. The method includes, while the WD is in a radio resource control, RRC, CONNECTED state, providing a propagation delay compensation, PDC, configuration to the WD. The method also includes, while the WD is in an RRC INACTIVE state or RRC IDLE state, signaling a time value to the WD. The PDC configuration includes a PDC value to be used by the WD in the RRC INACTIVE state or RRC IDLE state to compensate the time value when the PDC value is determined by the WD to be valid.

According to this aspect, in some embodiments, the time value transmitted by the network node is a coordinated universal time, UTC, or a global positioning system, GPS, time. In some embodiments, the PDC configuration includes at least one of a PDC method, a permission to update the PDC value, a PDC validation method and a time interval during which the PDC configuration is to be applied by the WD. In some embodiments, the PDC method is one of a timing advance-based method and a round trip time-based method. In some embodiments, the method includes providing a subsequent PDC configuration when the WD determines that the PDC value is invalid. In some embodiments, the method includes signaling to the WD a first threshold to compare with a signal measurement or a change in signal measurement to determine whether the PDC value is valid. In some embodiments, the method includes configuring the WD to transmit a sounding reference signal, SRS, during the RRC INACTIVE state. In some embodiments, the method includes configuring the WD to autonomously adjust the PDC value based at least in part on a time offset or a difference in downlink signal reception times. In some embodiments, the method includes configuring the WD to cease performing PDC when the WD is changing cells.

According to yet another aspect, a network node configured to communicate with a wireless device, WD, is provided. The network node is configured to: while the WD is in a radio resource control, RRC, CONNECTED state, provide a propagation delay compensation, PDC, configuration to the WD; and while the WD is in an RRC INACTIVE state or RRC IDLE state, signal a time value to the WD. The PDC configuration includes a PDC value to be used by the WD in the RRC INACTIVE state or RRC IDLE state to compensate the time value when the PDC value is determined by the WD to be valid.

According to this aspect, in some embodiments, the time value transmitted by the network node is a coordinated universal time, UTC, or a global positioning system, GPS, time. In some embodiments, the PDC configuration includes at least one of a PDC method, a permission to update the PDC value, a PDC validation method and a time interval during which the PDC configuration is to be applied by the WD. In some embodiments, the PDC method is one of a timing advance-based method and a round trip time-based method. In some embodiments, the network node is further configured to provide a subsequent PDC configuration when the WD determines that the PDC value is invalid. In some embodiments, the network node is configured to signal to the WD a first threshold to compare with a signal measurement or a change in signal measurement to determine whether the PDC value is valid. In some embodiments, the network node is configured to configured the WD to transmit a sounding reference signal, SRS, during the RRC INACTIVE state. In some embodiments, the network node is configured to configure the WD to autonomously adjust the PDC value based at least in part on a time offset or a difference in downlink signal reception times. In some embodiments, the network node is configured to configure the WD to cease performing PDC when the WD is changing cells.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a timing diagram showing timing between a network node and a wireless device;

FIG. 2 is a schematic diagram of an example network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating example methods implemented in a communication system including a host computer, a network node and a wireless device for executing a client application at a wireless device according to some embodiments of the present disclosure;

FIG. 5 is a flowchart illustrating example methods implemented in a communication system including a host computer, a network node and a wireless device for receiving user data at a wireless device according to some embodiments of the present disclosure;

FIG. 6 is a flowchart illustrating example methods implemented in a communication system including a host computer, a network node and a wireless device for receiving user data from the wireless device at a host computer according to some embodiments of the present disclosure;

FIG. 7 is a flowchart illustrating example methods implemented in a communication system including a host computer, a network node and a wireless device for receiving user data at a host computer according to some embodiments of the present disclosure;

FIG. 8 is a flowchart of an example process in a network node for wireless device (WD) propagation delay compensation in radio resource control (RRC) idle or inactive state;

FIG. 9 is a flowchart of an example process in a wireless device for wireless device (WD) propagation delay compensation in radio resource control (RRC) idle or inactive state;

FIG. 10 is a flowchart of an example process in a wireless device for wireless device (WD) propagation delay compensation in radio resource control (RRC) idle or inactive state; and

FIG. 11 is a flowchart of an example process in a network node for wireless device (WD) propagation delay compensation in radio resource control (RRC) idle or inactive state;

FIG. 12 is flowchart of another example process in a wireless device for wireless device (WD) propagation delay compensation in radio resource control (RRC) idle or inactive state.

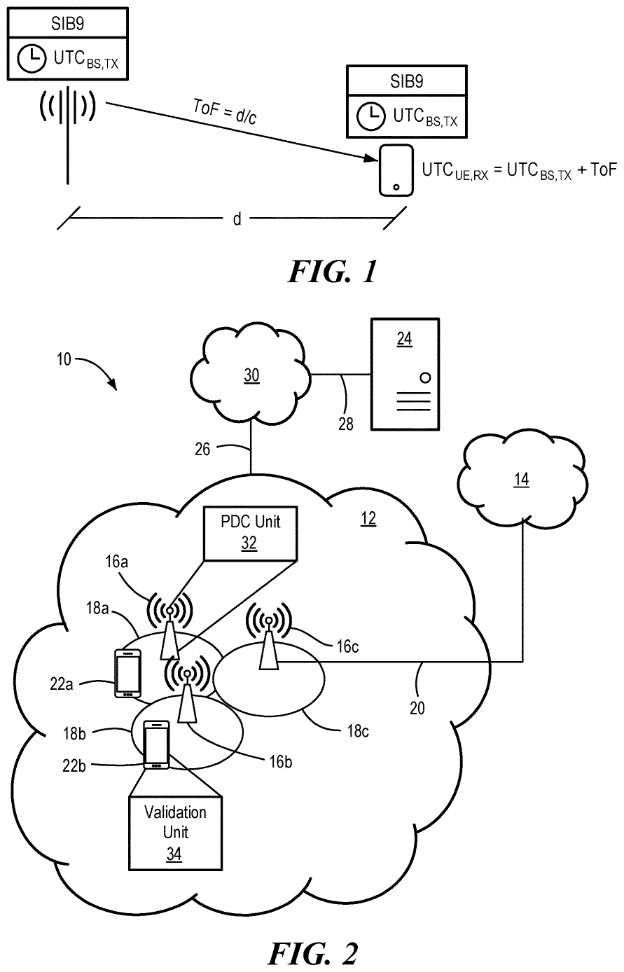

### DETAILED DESCRIPTION

Before describing in detail example embodiments, it is noted that the embodiments reside primarily in combinations of apparatus components and processing steps related to wireless device (WD) propagation delay compensation in radio resource control (RRC) idle or inactive state. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this may not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein may be interpreted as having a meaning that is consistent with their meaning in the context of this specification and the relevant art and will not be interpreted in an idealized or overly formal sense unless expressly so defined herein.

Some embodiments provide wireless device (WD) propagation delay compensation in radio resource control (RRC) idle or inactive state.

Returning now to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a PDC unit 32 which may be configured to determine a PDC value based at least in part on the sounding reference signal measurement. In some embodiments, the PDC unit 32 may be configured to provide a PDC configuration to the WD 22. A wireless device 22 is configured to include a validation unit 34 which may be configured to validate the PDC value. In some embodiments, the validation is based at least in part on one of a comparison of a difference in sounding reference signal, SRS, measurements to a first threshold and a comparison of a difference in timing advances to a second threshold.

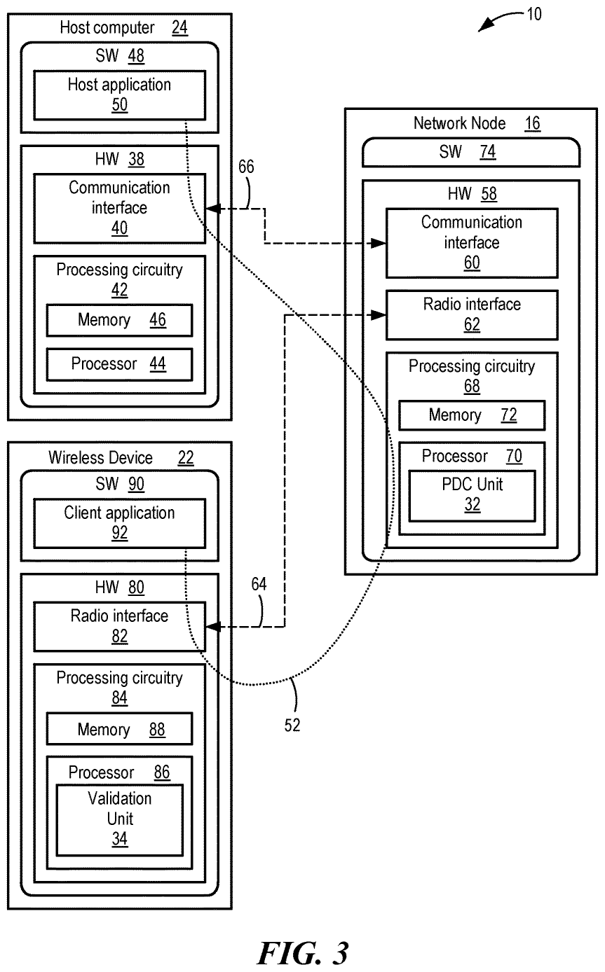

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a PDC unit 32 which is configured to determine a PDC value based at least in part on the sounding reference signal measurement.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a validation unit 34 which is configured to validate the PDC value based at least in part on one of a comparison of a difference in sounding reference signal, SRS, measurements to a first threshold and a comparison of a difference in timing advances to a second threshold.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure.

One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as PDC unit 32, and validation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

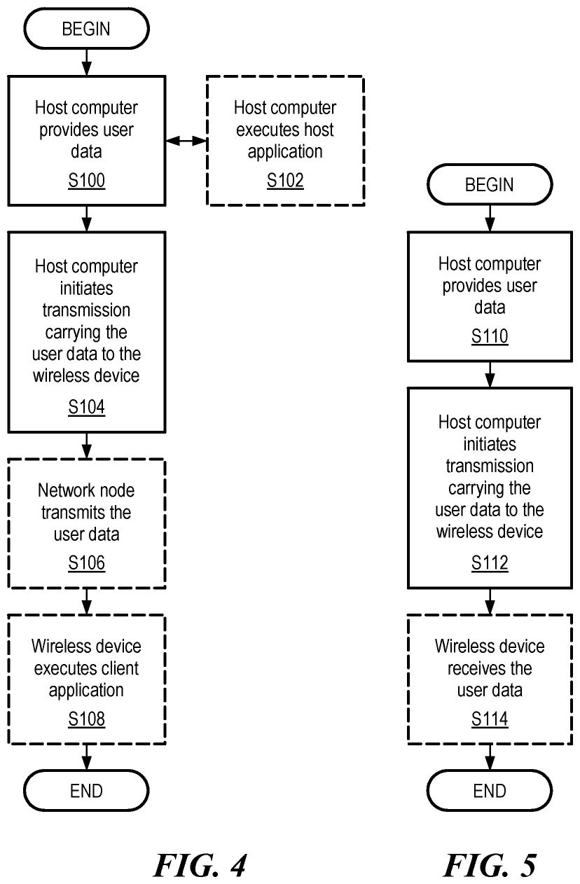

FIG. 4 is a flowchart illustrating an example method implemented in a communication system, such as, for example, the communication system of FIGS. 2 and 2, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

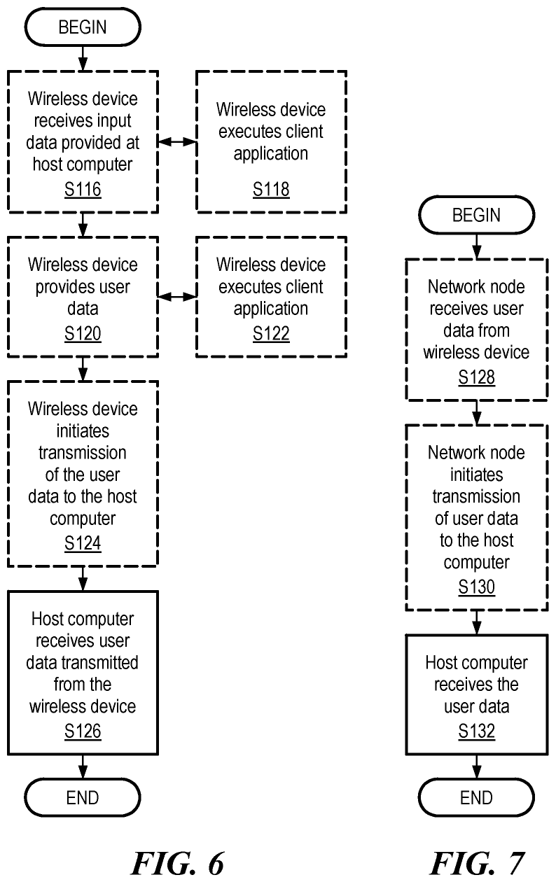

FIG. 6 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

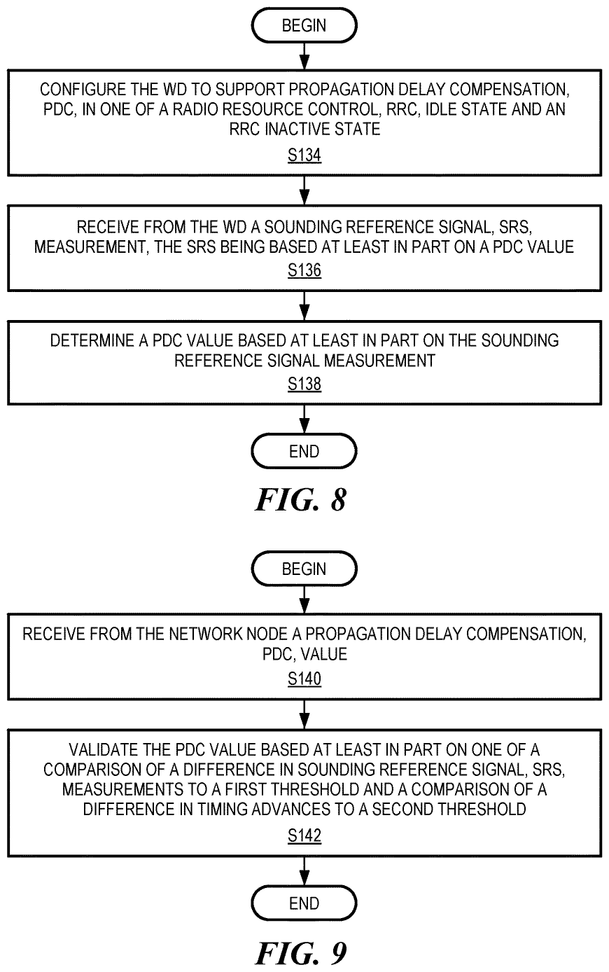

FIG. 8 is a flowchart of an example process in a network node 16 for wireless device (WD) propagation delay compensation in radio resource control (RRC) idle or inactive state. One or more blocks described herein may be performed by one or more elements of network node 16 such as by one or more of processing circuitry 68 (including the PDC unit 32), processor 70, radio interface 62 and/or communication interface 60. Network node 16 is configured to configure the WD 22 to support propagation delay compensation, PDC, in one of a radio resource control, RRC, idle state and a RRC inactive state (Block S134). The process also includes receiving from the WD 22 a sounding reference signal, SRS, measurement, the SRS being based on a PDC value (Block S136). The process further includes determining a PDC value based at least in part on the sounding reference signal measurement (Block S138).

In some embodiments, the process also include transmitting to the WD 22 a precompensated clock time, the precompensated clock time being based at least in part on the PDC value. In some embodiments, the method also includes configuring the WD 22 to autonomously adjust a PDC value based at least in part on a time offset. In some embodiments, the method also includes configuring the WD 22 to cease performing PDC when changing cells. In some embodiments, the method also includes configuring the WD 22 to autonomously adjust a PDC value based at least in part on a difference in times of reception of downlink signals.

FIG. 9 is a flowchart of an example process in a wireless device 22 according to some embodiments of the present. One or more blocks described herein may be performed by one or more elements of wireless device 22 such as by one or more of processing circuitry 84 (including the validation unit 34), processor 86, radio interface 82 and/or communication interface 60. Wireless device 22 is configured to receive from the network node a propagation delay compensation, PDC, value (Block S140). The process also includes validating the PDC value based at least in part on one of a comparison of a difference in sounding reference signal, SRS, measurements to a first threshold and a comparison of a difference in timing advances to a second threshold (Block S142).

In some embodiments, validation of the PDC value is further based on a change in channel state estimations over time. In some embodiments, validation of the PDC value is further based on one of a position and a rotation of the WD 22. In some embodiments, validation of the PDC value is further based on a local primary time source. In some embodiments, the PDC value is based on a difference between time offsets in radio resource control, RRC, active states and one of RRC inactive state and RRC idle state.

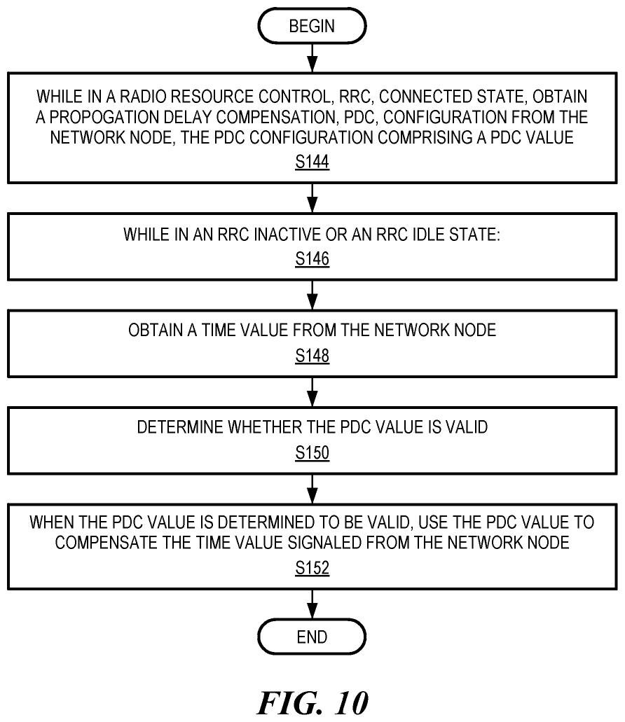

FIG. 10 is a flowchart of an example process in a wireless device 22 according to some embodiments of the present. One or more blocks described herein may be performed by one or more elements of wireless device 22 such as by one or more of processing circuitry 84 (including the validation unit 34), processor 86, radio interface 82 and/or communication interface 60. Wireless device 22 is configured to, while in a radio resource control, RRC, CONNECTED state, obtain a propagation delay compensation, PDC, configuration from the network node 16, the PDC configuration comprising a PDC value (S144). The method also includes, while in an RRC INACTIVE or an RRC IDLE state (S146): obtaining a time value signaled from the network node 16 (S148); determining whether the PDC value is valid (S150); and when the PDC value is determined to be valid, using the PDC value to compensate the time value signaled from the network node 16 (S152).

In some embodiments, the method includes, when the PDC value is determined to be invalid, entering the RRC CONNECTED state and acquiring a subsequent PDC configuration. In some embodiments, the method includes, when the PDC value is determined to be invalid, adjusting the PDC value while in the RRC IDLE state or the RRC INACTIVE state. In some embodiments, adjusting the PDC value is based at least in part on: a change in position of the WD relative to the network node since the time of obtaining the PDC value; a change in reception time of downlink signals; or a change in time offset toward a local primary time. In some embodiments, the time value received from the network node 16 is a coordinated universal time, UTC, or a global positioning system, GPS, time. In some embodiments, the method includes performing PDC based at least in part on the PDC value until the WD 22 changes cells. In some embodiments, determining whether the PDC value is valid is based at least in part on a detected change in a signal measurement that is less than a first threshold. In some embodiments, the signal measurement is one of a reference signal received power, a reference signal received quality, a signal to interference plus noise ratio and a signal to noise ratio. In some embodiments, the detected change in signal measurement includes a change between a first sample of a signal measurement performed at a first time and a second sample of a signal measurement performed at a second time after the first time, the first time being a time when the PDC value was obtained. In some embodiments, the PDC value is determined to be invalid when an absolute value of a detected change in signal measurements exceeds a second threshold. In some embodiments, determining whether the PDC value is valid includes comparing to a third threshold, a difference in time between receipt of a first signal and receipt of a second signal. In some embodiments, the first signal is one of a synchronization signal, a physical broadcast channel, a tracking reference signal and a positioning reference signal from a cell camped on by the WD 22. In some embodiments, the second signal is one of a synchronization signal, a physical broadcast channel, a tracking reference signal and a positioning reference signal from a neighbor cell to a cell camped on by the WD 22. In some embodiments, determining whether the PDC value is valid includes determining a change in signal measurements over a sequence of times. In some embodiments, determining whether the PDC value is valid includes comparing to a fourth threshold a change in at least one of position and orientation of the WD 22. In some embodiments, determining whether the PDC value is valid includes comparing the time value signaled from the network node 16 and a local primary time In some embodiments, the local primary time is a global navigation satellite system time. In some embodiments, the PDC configuration includes at least one of a PDC method, a permission to update the PDC value, a PDC validation method and a time interval during which the PDC configuration is to be applied by the WD 22. In some embodiments, the PDC method is one of a timing advance-based method and a round trip time-based method. In some embodiments, the round trip time-based method includes transmitting sounding reference signals, SRS, in RRC INACTIVE state, and the WD is configured to receive a time difference value based on measurements of SRS by the network node.

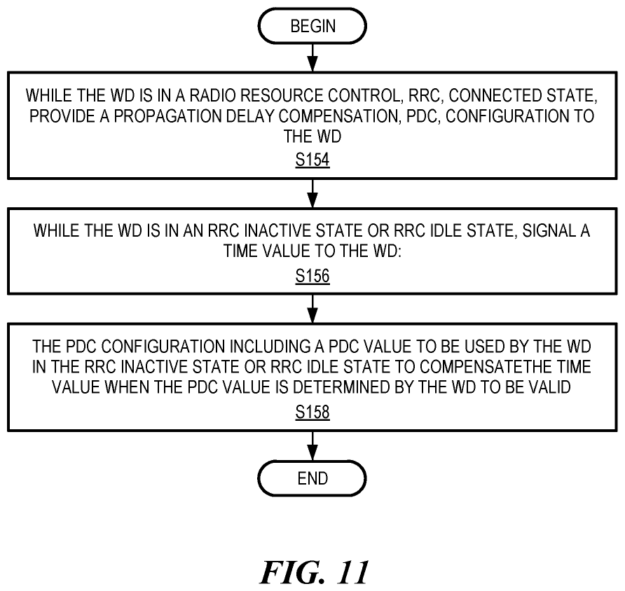

FIG. 11 is a flowchart of an example process in a network node 16 for wireless device (WD) propagation delay compensation in radio resource control (RRC) idle or inactive state. One or more blocks described herein may be performed by one or more elements of network node 16 such as by one or more of processing circuitry 68 (including the PDC unit 32), processor 70, radio interface 62 and/or communication interface 60. Network node 16 is configured to, while the WD 22 is in a radio resource control, RRC, CONNECTED state, provide a propagation delay compensation, PDC, configuration to the WD 22 (S154). The method also includes, while the WD 22 is in an RRC INACTIVE state or RRC IDLE state, signaling a time value to the WD 22 (S156). The PDC configuration includes a PDC value to be used by the WD 22 in the RRC INACTIVE state or RRC IDLE state to compensate the time value when the PDC value is determined by the WD 22 to be valid (S158).

According to this aspect, in some embodiments, the time value transmitted by the network node 16 is a coordinated universal time, UTC, or a global positioning system, GPS, time. In some embodiments, the PDC configuration includes at least one of a PDC method, a permission to update the PDC value, a PDC validation method and a time interval during which the PDC configuration is to be applied by the WD 22. In some embodiments, the PDC method is one of a timing advance-based method and a round trip time-based method. In some embodiments, the method includes transmitting a next PDC configuration when the WD 22 determines that the PDC value is invalid. In some embodiments, the method includes signaling to the WD 22 a first threshold to compare with a signal measurement or a change in signal measurement to determine whether the PDC value is valid. In some embodiments, the method includes configuring the WD 22 to transmit a sounding reference signal, SRS, during the RRC INACTIVE state. In some embodiments, the method includes configuring the WD 22 to autonomously adjust the PDC value based at least in part on a time offset or a difference in downlink signal reception times. In some embodiments, the method includes configuring the WD 22 to cease performing PDC when the WD 22 is changing cells.

Having described the general process flow of arrangements of the disclosure and having provided examples of hardware and software arrangements for implementing the processes and functions of the disclosure, the sections below provide details and examples of arrangements for wireless device (WD) propagation delay compensation in radio resource control (RRC) idle or inactive state.

One or more network node 16 functions described below may be performed by one or more of processing circuitry 68, processor 70, PDC unit 32, etc. One or more wireless device 22 functions described below may be performed by one or more of processing circuitry 84, processor 86, validation unit 34.

### Configuring a WD to Perform PDC in RRC Inactive/Idle

In some embodiments, a WD 22 in RRC connected state is configured to perform PDC on a time (e.g., from a global positioning system (GPS) or UTC) signaled by the network in a subsequent RRC inactive or idle state.

Some embodiments, provide a configuration of one or more of a PDC method (e.g., TA based or RTT based), a PDC value, a permission to update the PDC value, a PDC validation method, and a time interval during which the configuration is applied.

### PDC Validation

In some embodiments, a WD 22 assumes that a pre-configured or previously stored PDC value is validated based on a detected difference ΔS in a measured signal value being not larger than a configured threshold. The threshold may be based on an additional allowed and assigned delta error margin for when PDC is performed in connected mode. The margin may be chosen to allow an air interface budget to be within its allowed fraction of a total time distribution budget.

Examples of the measured value are RSRP, reference signal received quality (RSRQ), signal to interference plus noise ratio (SINR), and signal to noise ratio (SNR).

Examples of the measured signal are primary and secondary synchronization signals (PSS, SSS), the physical broadcast channel (PBCH), the tracking reference signal (TRS) and the positioning reference signal (PRS).

The difference in the measured value S is defined as the difference between a first sample S1 of the value measured at a first time, and a second sample S2 measured at a later second time. The first time may correspond to the time at which the WD 22 in RRC Connected state was configured by the network node to perform PDC in a subsequent RRC inactive state or idle state. The second later time may correspond to the time when the WD 22 intends to apply the PDC to a received UTC in an RRC inactive state or idle state.

If the WD 22 detects a difference ΔS=abs(S1−S2) in the measured value that exceeds the threshold, the WD 22 considers the PDC to be outdated and invalid. Before continuing performing PDC from RRC inactive state or idle state, the WD 22 may obtain a new PDC configuration from the network/network node 16. A configured threshold may be set to an infinite value to allow a WD 22 to always perform PDC from inactive state or idle state.

In some embodiments, the pre-configured PDC value is validated based on a difference ΔT in a first received signal time TA relative to a second received signal time TB not changing by more than a configured threshold.

Examples of the first received signal include primary and secondary synchronization signals (PSS, SSS), the physical broadcast channel (PBCH), the tracking reference signal (TRS) and the positioning reference signal (PRS) from a first cell which the WD 22 camps on.

Examples of the second received signal include primary and secondary synchronization signals (PSS, SSS), the physical broadcast channel (PBCH), the tracking reference signal (TRS) and the positioning reference signal (PRS) from a second neighbor cell.

The change dT in the measured time difference is defined as the time difference ΔT1 between a first and a second signal measured at a first time, relative to the time difference ΔT2 between the first and a second signal measured at a second time, i.e., dt=ΔT1−ΔT2. The first measurement time may correspond to the time at which the WD 22 was configured by the network node 16 to perform PDC in a subsequent RRC inactive state or idle state. The second later measurement time may correspond to the time when the WD 22 intends to apply the PDC to a received UTC in an RRC inactive state or idle state.

In some embodiments, the WD 22 may estimate the radio channel at multiple time instances (e.g., based on received demodulation reference symbols (DMRS)) and validate the PDC value based on detected changes in the estimated channel over time. The channel may, for example, be represented as a tapped delay line (TDL) with each tap representing a received signal path. Change in the timing, magnitude or phase of the strongest channel tap, as well as other taps, in the TDL exceeding a threshold may serve as an indication that the WD 22 has moved. In some embodiments, this calls for invalidating the pre-configured PDC value. Other ways to capture a change in a channel would be to detect changes in the center of gravity

$$\frac{1}{P} {\sum }_{i = 1}^{n} {p}_{i} {t}_{i}$$

(where P is the estimated total power and pᵢ is the power at receive time tᵢ) between channel estimates. The changes in the center of gravity may be compared to a threshold. Some embodiments may employ changes in some function defining a way to measure a distance between channels. For example, a function such as

$${\sum }_{i = 1}^{n} {( {p}_{1 , i} - {p}_{2 , i} )}^{2} ,$$

if p_{1,i} and p_{2,i} are channel power taps for the channel, for different estimates of the channel, at sample times i, may be defined.

In some embodiments the pre-configured PDC value is validated based on a change in position or rotation of the device being above a threshold value, causing a change of channel to the node distributing the time information. A change in position of a device may be estimated based on an internal global navigation satellite system (GNSS) receiver, for example, based on an observed time difference of arrival from multiple base stations and an internal Inertial Measurement Unit (IMU). The IMU may also be used to detect rotation of the WD 22 with knowledge about device antenna characteristics to evaluate a potential change in channel conditions that may affect the propagation delay.

In some embodiments, the pre-configured PDC value is validated by using another local primary time source (e.g., a local GNSS receiver) when the 5G system provides time as a service (Taas) as a back up to the primary time source. By comparing a change in time offset for the 5G system time at RRC connected state (with updated PDC) and under RRC inactive/idle state mode towards the primary source time reference, the WD 22 may relate a change in offset towards the primary source to a change in channel propagation delay.

In the following, the signaling and procedure for two methods of supporting propagation delay compensation (PDC) are described for WD 22 in RRC_INACTIVE state: TA-based method, and RTT-based method.

### TA-Based Method in RRC_INACTIVE Based on RSRP-Change Validation

For the timing advance (TA) based method, a valid timing advance value may be obtained, even though the WD 22 is in RRC_INACTIVE state and there is very little communication between the WD 22 and the network node.

In some embodiments, the TA value obtained from an earlier procedure (e.g., from medium access control (MAC) timing advance command or from random access procedure) was stored, and the stored TA value may continue to be considered valid if certain conditions are satisfied. The conditions indicate that the WD 22 has not moved far from the location when the stored TA value was estimated. Typical conditions include: (a) channel measurement (e.g., RSRP, RSRQ, L1-RSRP) has not changed from the stored channel measurement by more than a predefined threshold; and (b) the timer that was set to keep track of freshness of the time alignment has not expired (i.e., the stored TA value is not too old).

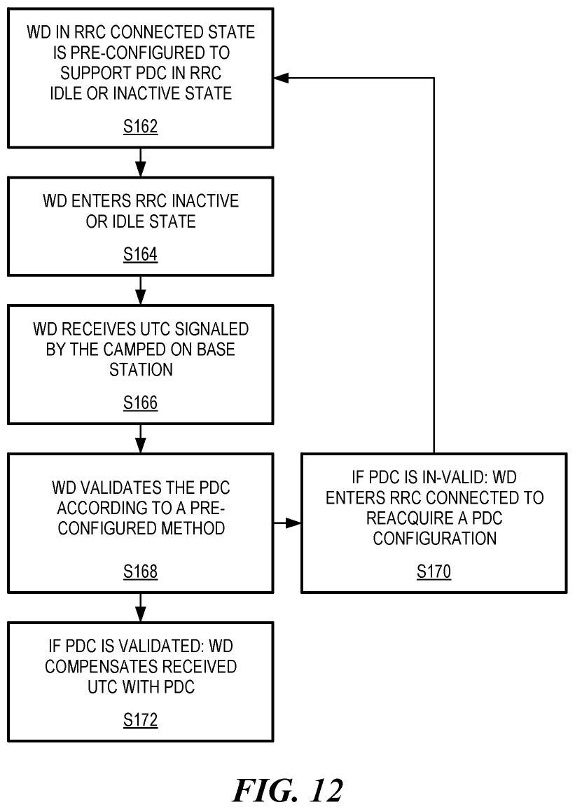

In the following, the example MAC procedure in FIG. 12, where sync-RSRP-ChangeThreshold represents an RRC parameter that ensures that the channel measurement has not varied significantly from the channel condition when the stored TA value was estimated; sync-TimeAlignmentTimer represents a RRC parameter that ensures that the not too much time has elapsed since the time the TA value was estimated and stored.

The MAC entity may be configured as follows:
1> if the WD 22 receives an indication to move from RRC CONNECTED to RRC_INACTIVE:
2> store the RSRP of the downlink pathloss reference with the current RSRP value of the downlink pathloss reference;
1> if Timing Advance Command MAC CE is received or;
1> if Timing Advance Command or Absolute Timing Advance Command is received for Random Access procedure that is successfully completed:
2> update the stored downlink pathloss reference with the current RSRP value of the downlink pathloss reference.

When the WD 22 is in RRC_INACTIVE, the MAC entity may be configured to consider the most recently stored TA to be valid when the following condition is fulfilled:
1> compared to the stored downlink pathloss reference RSRP value, the current RSRP value of the downlink pathloss reference has not increased/decreased by more than sync-RSRP-ChangeThreshold, if configured; and
1> sync-TimeAlignmentTimer is running.

If the most recently stored TA is validated as above, then the WD 22 may use the validated TA value to derive the propagation delay compensation value, in order to obtain the synchronized clock time at the WD 22.

In the procedure above, it was assumed that the WD 22 is the entity that takes the stored TA value and performs propagation delay compensation.

Alternatively, it is also possible that the network node 16 validates a stored TA value, and performs pre-compensation of the 5GS clock with the stored TA, and then the network node 16 sends the already compensated clock time to the WD 22. With pre-compensation by the network node, the WD 22 may receive and use the clock time directly, so there is no need for the WD 22 to perform propagation delay compensation).

### RTT-Based Method in RRC_INACTIVE

For propagation delay compensation at the WD:

The network node 16 may configure the WD 22 to transmit periodic or semi-persistent positioning sounding reference signals (SRS) in RRC_INACTIVE state. Then the network node 16 may determine network node RxTxTimDiff based on the measurement of positioning SRS. Next, the network node 16 may send the network node RxTxTimeDiff value to WD 22 in RRC Inactive or idle state as part of small data transmission (SDT).

In the meantime, the WD 22 may measure the positioning reference signal (PRS) of the serving cell to obtain WD RxTxTimeDiff. With the network node RxTxTimeDiff value and the WD RxTxTimeDiff value, the WD 22 may derive the propagation delay compensation value, thus obtaining the synchronized clock time at the WD 22.

For propagation delay compensation at the network node:

The WD 22 may measure the positioning reference signal (PRS) of the serving cell to obtain WD RxTxTimeDiff. Then, the WD 22 in RRC inactive or idle state sends its estimated WD RxTxTimeDiff value to the network node as part of small data transmission (SDT).

While the WD 22 is in RRC_INACTIVE, the network node may configure the WD 22 to transmit periodic or semi-persistent positioning SRS. The network node 16 may determine network node RxTxTimDiff based on the measurement of positioning SRS. With the network node RxTxTimeDiff value and the WD RxTxTimeDiff value, the network node 16 may derive the propagation delay compensation value, and pre-compensate the 5GS clock time for the target WD 22. Then, the network node 16 may send the pre-compensated clock time in a dedicated message to the target WD 22.

### WD 22 Autonomous PDC Adjustment

In some embodiments, a WD 22 is configured to autonomously adjust its pre-configured PDC value in RRC Idle or Inactive state.

### Positioning Based Approach

The WD 22 may update a previous PDC value P1 based on a known change in position by a distance d relative to a network node 16 on which the WD 22 is camped, since the time of obtaining the PDC P1. A new updated PDC value P2 may be calculated as P2=P1+d/c, with c equal to the speed of light. This may be done when the WD 22 increases its distance to the camped-on network node that provides the broadcasted UTC. If the distance to the base station decreases, the new PDC is calculated as P2=P1−d/c.

The distance d may be based on the WD 22 obtaining the bases station position via high layer signaling, and its own position by the use of GNSS.

### Downlink Timing Change Approach

In some embodiments, the WD 22 is configured to autonomously adjust to perform PDC based on difference in reception time of downlink signals. If the downlink signal drifts over time, the WD 22 may determine that the WD 22 has moved and the downlink propagation delay has changed. For example, if the WD 22 moves away from the network node the downlink signals received from that node will reach later (compared to when the WD 22 was not moving). The WD 22 may measure this change in downlink timing and estimates the DL propagation delay to calculate the downlink timing. If the DL timing is delayed with a delta D, the WD 22 may calculate the time as the received signaled time+D.

### Primary Time Source Reference Approach

In some embodiments, the WD 22 is configured to autonomously adjust PDC based on a change in time offset towards another local primary time source (e.g., a local GNSS receiver) when the 5G system provides time as a service (Taas) as a back up to the primary time source. By comparing a change in time offset for the 5G system time at RRC connected state (with updated PDC) and under RRC inactive/idle state towards the primary source time reference, the WD 22 may relate a change in offset towards the primary source to a change in channel propagation delay and compensate for that.

### Cell Reselection

In some embodiments, the WD 22 may be configured to stop performing PDC when changing cells. If the WD 22 was connected to a first cell when in CONNECTED and is determined to perform PDC while in IDLE/INACTIVE, the WD 22 may stop performing PDC when changing to the 2^{nd} cell. The WD 22 may further consider the current time information invalid upon cell reselection. The WD 22 may upon cell change reacquire a fresh PDC value and then resume the PDC.

In some embodiments, the WD 22 may measure the time offset when receiving time from the first cell and receiving time from the second cell and use the offset to compensate a PDC related to the first cell and use the compensated PDC when receiving time from the second cell. A condition for such approach may be that the time error between the cells (between the cells antenna reference point) is below a threshold and hence the difference in time mainly relates to a difference in radio frequency (RF) propagation delay.

It may be that one node is hosting multiple cells. In this scenario, it may be that the timing information received from one cell of the node may be applied when the WD 22 is camping on another cell supported from the same node. Hence, the WD 22 may determine that the timing information from a first cell may be applied when the WD 22 is under a second cell, but not a third cell. The cell(s) the WD 22 may move to while considering the timing information received from a first cell as valid may be indicated by the network. This may for example be indicated in the configuration.

Some embodiments may include one or more of the following:

Embodiment A1. A network node configured to communicate with a wireless device (WD), the network node configured to, and/or comprising a radio interface and/or comprising processing circuitry configured to:
configure the WD to support propagation delay compensation, PDC, in one of a radio resource control, RRC, idle state and a RRC inactive state;
receive from the WD a sounding reference signal, SRS, measurement, the SRS being based at least in part on a PDC value; and
determine a PDC value based at least in part on the sounding reference signal measurement.

Embodiment A2. The network node of Embodiment A1, wherein the network node, radio interface and/or processing circuitry are further configured to transmit to the WD a precompensated clock time, the precompensated clock time being based at least in part on the PDC value.

Embodiment A3. The network node of any of Embodiments A1 and A2, wherein the network node, radio interface and/or processing circuitry are further configured to configure the WD to autonomously adjust a PDC value based at least in part on a time offset.

Embodiment A4. The network node of any of Embodiments A1-A3, wherein the network node, radio interface and/or processing circuitry are further configured to configure the WD to cease performing PDC when changing cells.

Embodiment A5. The network node of any of Embodiments A1-A4, wherein the network node, radio interface and/or processing circuitry are further configured to configure the WD to autonomously adjust a PDC value based at least in part on a difference in times of reception of downlink signals.

Embodiment B1. A method implemented in a network node, the method comprising:
configuring the WD to support propagation delay compensation, PDC, in one of a radio resource control, RRC, idle state and a RRC inactive state;
receiving from the WD a sounding reference signal, SRS, measurement, the SRS being based at least in part on a PDC value; and
determining a PDC value based at least in part on the sounding reference signal measurement.

Embodiment B2. The method of Embodiment B1, further comprising transmitting to the WD a precompensated clock time, the precompensated clock time being based at least in part on the PDC value.

Embodiment B3. The method of any of Embodiments B1 and B2, further comprising configuring the WD to autonomously adjust a PDC value based at least in part on a time offset.

Embodiment B4. The method of any of Embodiments B1-B3, further comprising configuring the WD to cease performing PDC when changing cells.

Embodiment B5. The method of any of Embodiments B1-B4, further comprising configuring the WD to autonomously adjust a PDC value based at least in part on a difference in times of reception of downlink signals.

Embodiment C1. A wireless device (WD) configured to communicate with a network node, the WD configured to, and/or comprising a radio interface and/or processing circuitry configured to:
receive from the network node a propagation delay compensation, PDC, value; and
validate the PDC value based at least in part on one of a comparison of a difference in sounding reference signal, SRS, measurements to a first threshold and a comparison of a difference in timing advances to a second threshold.

Embodiment C2. The WD of Embodiment C1, wherein validation of the PDC value is further based on a change in channel state estimations over time.

Embodiment C3. The WD of any of Embodiments C1 and C2, wherein validation of the PDC value is further based on one of a position and a rotation of the WD.

Embodiment C4. The WD of any of Embodiments C1-C3, wherein validation of the PDC value is further based on a local primary time source.

Embodiment C5. The WD of any of Embodiments C1-C3, wherein the PDC value is based on a difference between time offsets in radio resource control, RRC, active states and one of RRC inactive state and RRC idle state.

Embodiment D1. A method implemented in a wireless device (WD), the method comprising:
receiving from the network node a propagation delay compensation, PDC, value; and
validating the PDC value based at least in part on one of a comparison of a difference in sounding reference signal, SRS, measurements to a first threshold and a comparison of a difference in timing advances to a second threshold.

Embodiment D2. The method of Embodiment D1, wherein validation of the PDC value is further based on a change in channel state estimations over time.

Embodiment D3. The method of any of Embodiments D1 and D2, wherein validation of the PDC value is further based on one of a position and a rotation of the WD.

Embodiment D4. The method of any of Embodiments D1-D3, wherein validation of the PDC value is further based on a local primary time source.

Embodiment D5. The method of any of Embodiments D1-D3, wherein the PDC value is based on a difference between time offsets in radio resource control, RRC, active states and one of RRC inactive state and RRC idle state.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3^{rd} Generation Partnership Project
5GS 5G system
NR New Radio
PDC Propagation delay compensation
RRC Radio resource control
SDT Small data transmission
Taas Time as a service
TSN Time sensitive networking
UTC Universal Coordinated Time

It will be appreciated by persons skilled in the art that the embodiments described herein are not limited to what has been particularly shown and described herein above. In addition, unless mention was made above to the contrary, it may be noted that all of the accompanying drawings are not to scale. A variety of modifications and variations are possible in light of the above teachings without departing from the scope of the following claims.

1. A method in a wireless device, WD, configured to communicate with a network node, the method comprising:
while in a radio resource control, RRC, CONNECTED state, obtaining a propagation delay compensation, PDC, configuration from the network node, the PDC configuration comprising a PDC value; and
while in an RRC INACTIVE or an RRC IDLE state:
obtaining a time value signaled from the network node;
determining whether the PDC value is valid; and
when the PDC value is determined to be valid, using the PDC value to compensate the time value signaled from the network node.

2. The method of claim 1, further comprising, when the PDC value is determined to be invalid, entering the RRC CONNECTED state and acquiring a subsequent PDC configuration.

3. The method of claim 1, further comprising, when the PDC value is determined to be invalid, adjusting the PDC value while in the RRC IDLE state or the RRC INACTIVE state.

4. The method of claim 3, wherein adjusting the PDC value is based at least in part on:
a change in position of the WD relative to the network node since the time of obtaining the PDC value;
a change in reception time of downlink signals; or
a change in time offset toward a local primary time.

5. The method of claim 1, wherein the time value signaled from the network node is a coordinated universal time, UTC, or a global positioning system, GPS, time.

6. The method of claim 1, further comprising performing PDC based at least in part on the PDC value until the WD changes cells.

7. The method of claim 1, wherein determining whether the PDC value is valid is based at least in part on a detected change in a signal measurement that is less than a first threshold.

8. The method of claim 7, wherein the signal measurement is one of a reference signal received power, a reference signal received quality, a signal to interference plus noise ratio and a signal to noise ratio.

9. The method of claim 7, wherein the detected change in signal measurement includes a change between a first sample of a signal measurement performed at a first time and a second sample of a signal measurement performed at a second time after the first time, the first time being a time when the PDC value was obtained.

10. The method of claim 7, wherein the PDC value is determined to be invalid when an absolute value of a detected change in signal measurements exceeds a second threshold.

11. The method of claim 1, wherein determining whether the PDC value is valid includes comparing to a third threshold, a difference in time between receipt of a first signal and receipt of a second signal.

12. The method of claim 11, wherein the first signal is one of a synchronization signal, a physical broadcast channel, a tracking reference signal and a positioning reference signal from a cell camped on by the WD.

13. The method of claim 10, wherein the second signal is one of a synchronization signal, a physical broadcast channel, a tracking reference signal and a positioning reference signal from a neighbor cell to a cell camped on by the WD.

14. The method of claim 1, wherein determining whether the PDC value is valid includes determining a change in signal measurements over a sequence of times.

15. The method of claim 1, wherein determining whether the PDC value is valid includes comparing to a fourth threshold a change in at least one of position and orientation of the WD.

16.-20. (canceled)

21. A wireless device, WD, configured to communicate with a network node, the WD configured to:
while in a radio resource control, RRC, CONNECTED state, obtain a propagation delay compensation, PDC, configuration from the network node, the PDC configuration comprising a PDC value; and
while in an RRC INACTIVE or an RRC IDLE state:
obtain a time value signaled from the network node;
determine whether the PDC value is valid; and
when the PDC value is determined to be valid, use the PDC value to compensate the time value signaled from the network node.

22.-24. (canceled)

25. The WD of claim 21, wherein the time value signaled from the network node is a coordinated universal time, UTC, or a global positioning system, GPS, time.

26.-40. (canceled)

41. A method in a network node configured to communicate with a wireless device, WD, the method comprising:
while the WD is in a radio resource control, RRC, CONNECTED state, providing a propagation delay compensation, PDC, configuration to the WD;
while the WD is in an RRC INACTIVE state or RRC IDLE state, signaling a time value to the WD; and
the PDC configuration including a PDC value to be used by the WD in the RRC INACTIVE state or RRC IDLE state to compensate the time value when the PDC value is determined by the WD to be valid.

42. The method of claim 41, wherein the time value signaled to the WD is a coordinated universal time, UTC,
or a global positioning system, GPS, time.

43.-49. (canceled)

50. A network node configured to communicate with a wireless device, WD, the network node configured to:
while the WD is in a radio resource control, RRC, CONNECTED state, provide a propagation delay compensation, PDC, configuration to the WD;
while the WD is in an RRC INACTIVE state or RRC IDLE state, signal a time value to the WD; and
the PDC configuration including a PDC value to be used by the WD in the RRC INACTIVE state or RRC IDLE state to compensate the time value when the PDC value is determined by the WD to be valid.

51.-58. (canceled)
